(19) United States
(12) Patent Application Publication
(10) Pub. No.: US 2010/0310433 A1
(43) Pub. Date: Dec. 9, 2010

(54) DEVICE FOR TREATMENT OF FLUIDS

(75) Inventors: Kristoffer Nyberg, Stockholm (SE); David Stenman, Enebyberg (SE)

Correspondence Address: YOUNG & THOMPSON, 209 Madison Street, Suite 500, Alexandria, VA, 22314, US

(73) Assignee: WALLENIUS WATER AKTIEBOLAG, Stockholm (SE)

(21) Appl. No.: 12/745,256

(22) PCT Filed: Dec. 2, 2008
(86) PCT No.: PCT/SE2008/051390

§ 371 Date: Jun. 24, 2010

(30) Foreign Application Priority Data
Dec. 5, 2007 (SE) 0702742-8

(51) Int. Cl. B01J 19/08

(52) U.S. Cl. 422/186.3

(57) ABSTRACT

A device for treatment of fluids, includes a treatment chamber having an inlet and an outlet for the fluid to be treated, elongated UV light generating elements arranged inside the treatment chamber, a photo-catalytic structure arranged in the treatment chamber. The photo-catalytic structure is a filter arranged in the flow of fluid through the treatment chamber such that the fluid flows through the filter. The filter is designed generally tubular and placed adjacent and surrounding the UV light generating elements for radiating the filter with UV light, thereby creating treatment radicals, and the filter is placed such that the whole flow of fluid is forced through the radiated filter.

### TECHNICAL AREA

The present invention relates to treatment of fluids such as water, air and other types of gases and liquids, and according to one aspect of the invention, of tap water in domestic water piping systems.

### BACKGROUND OF THE INVENTION

During cleaning of fluids, in some cases equipment is used that create photo-catalytic effects. It may comprise UV-generating light sources capable of, within an enclosure filled with fluid, irradiate the fluid whereby ozone is created. In order to obtain a photo-catalytic effect a surface with photo-catalytic properties are arranged, such as titanium dioxide capable of converting the light into free radicals through photo-catalysis, or breaks down the ozone and creates free radicals, which are far more aggressive against organisms than the ozone.

For some cleaning equipment that work with this type of technology a limited photo-catalytic effect is obtained, which mainly depends on that the photo-catalytic surface is in a border layer in the flow profile of the cleaner. Further, the photo-catalytic effect is limited in that the titanium dioxide surface for some types of cleaners are placed on a relatively large distance from the light source.

At the same time as it is desirable to obtain a high production of radicals by photo-catalysis it is also desirable to generate radicals by photolysis. The photolysis is in these types of equipment a volume process in contrast to the photo-catalysis which is a surface process. At the same time, during applications where the killing of micro organisms is of interest, also interested in direct UV inactivation, which also is a volume process. The problem is that it is difficult to increase the photo-catalytic generation of radicals without suppressing the volume processes by blocking the light or obtaining too short processing time. Also the use of different kinds of nets gives substantial shadowing effects that suppress the use of the supplied photon energy.

What is desirable to obtain is to have a photo-catalytic surface that is placed close to the light source and that all fluid passes close thereto, without reducing the volume processes in a significant way.

### BRIEF DESCRIPTION OF THE INVENTION

The aim of the present invention is to remedy the drawbacks of the state of the art technology. This aim is obtained according to the features of the independent patent claim 1.

Preferable embodiments of the invention form the subject of the dependent patent claims.

According to a main aspect of the present invention it relates to a device for treatment of fluids, comprising a treatment chamber having an inlet and an outlet for the fluid to be treated, elongated UV light generating means arranged inside said treatment chamber, a photo-catalytic structure arranged in said treatment chamber, that said photo-catalytic structure is a filter arranged in the flow of fluid through the treatment chamber such that the fluid flows through said filter, wherein said filter is designed generally tubular and placed adjacent and surrounding said UV light generating means for radiating said filter with UV light, thereby creating treatment radicals, and wherein said filter is placed such that the whole flow of fluid is forced through the radiated filter.

In this aspect, the word fluids is to be interpreted to encompass liquids as well as gases of different content and temperature and for a number of applications ranging over treatment of air in domestic facilities to heavily polluted industrial liquids. Thus the present invention covers a large number of environmental aspects and applications where the fluid in question needs to be treated in order to render it harmless to the environment.

According to a further aspect of the invention, said photo-catalytic filter comprises a net structure having a plurality of openings through which the fluid may flow.

According to yet an aspect of the invention, said photo-catalytic filter is made of a material displaying photo-catalytic properties. Alternatively the surfaces of said photo-catalytic structure are covered with a material displaying photo-catalytic properties. Another alternative is to have a material displaying photo-catalytic properties is dispersed in the material of said photo-catalytic structure.

Preferably said photo-catalytic structure comprises a base material of quartz glass.

According to another aspect of the invention, the mesh size is chosen such that the photo-catalytic structure acts as a filter.

According to a further aspect of the invention, said UV light generating means comprises low energy lamps such as LED's, Xenon flash lamps, deuterium lamps.

The advantages with the present invention is that the whole stream of fluid to be treated is forced through the photo-catalytic filter, which in turn is placed adjacent the UV generating means, whereby a very good exposure of the fluid is obtained improving the formation of radicals and thereby improving the treatment.

Preferably the photo-catalytic filter is in the form of a net or the like structure with a plurality of perforations. Further this net structure contains photo-catalytic material, in all providing large photo-catalytic areas that are exposed to UV radiation.

In order to further enhance the exposure, the base material of the photo-catalytic filter may be made of a UV light transparent material, thereby enhancing the spreading of the UV light.

There is a further large advantage with the net-shape of the photo-catalytic filter and that it acts as a mechanical filter as well as photo-catalytic area. The filter function is of particular importance when treating fluids containing organisms that need to be killed off in order to, for example, prevent them from spreading diseases.

Because the generation of radicals is the strongest at the irradiated surfaces of the photo-catalytic filter, an extremely strong exposure is obtained when these organisms are caught in the filter, i.e. in direct contact with the photo-catalytic surfaces that are exposed to UV radiation.

In all a very powerful, versatile and flexible device for treating fluids is obtained with the present invention.

These and other aspects of and advantages with the present invention will become apparent from the following detailed description and from the appended drawings.

### BRIEF DESCRIPTION OF THE DRAWINGS

In the following detailed description of the invention reference will be made to the attached drawings of which,

FIG. 1a,b show cross-sectional views of a first embodiment of the present invention,

FIG. 2a,b show cross-sectional views of a second embodiment of the present invention,

FIG. 3 shows a cross-sectional view of a third embodiment of the present invention, and

FIG. 4 shows a cross-sectional view of a fourth embodiment of the present invention.

### DETAILED DESCRIPTION OF THE INVENTION

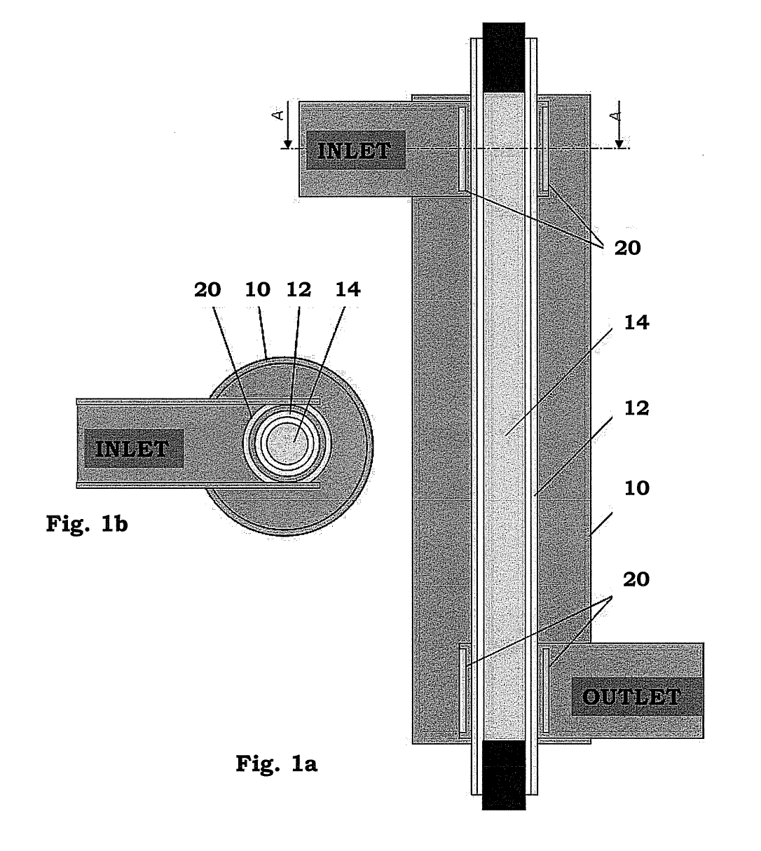

FIG. 1a, b show a first embodiment of the present invention. It comprises an elongated tubular casing 10 made of a material capable of withstanding all sorts of fluids. The inner surface of the casing is covered with a photo-catalytic layer or the material of the casing could be made of a material exhibiting photo-catalytic properties. One such material is titanium where titanium dioxide acts as a catalyst. The catalytic material could also be embedded in a suitable polymer, such as poly-tetra-fluor-ethylene (PTFE) which in addition to holding the photo-catalytic material and protecting the inner surface of the casing, also is capable of reflecting light of certain wavelengths.

The casing is arranged with an elongated tubular structure 12 positioned in the centre of the casing. The tubular structure is made of a UV light transparent material such as quartz glass. Inside the quartz tube a UV generating means 14 is arranged, in the embodiment shown an elongated lamp capable of emitting light in the spectra of 180-400 nm. The UV lamp is connected in appropriate ways to a suitable power source (not shown). The quartz tube and the UV lamp extend through the end walls of the casing and are supported there.

The casing is further arranged with an inlet pipe 16 and an outlet pipe 18, connectable to a piping system containing fluid to be treated. As seen in FIG. 1b, the inlet and outlet pipes surround the quartz tube and thus the UV lamp. On each side of the quartz tube, in the inlet and outlet pipes, nets 20 having certain mesh size are arranged. The nets are either covered with, or made by, material having photo-catalytic properties. The nets are thus placed very close to the UV lamp.

In use, when the fluid is flowing through the inlet and outlet and through the nets 20, all the fluid in the pipes passing through the nets will be irradiated with UV light, which in combination with the photo-catalytic material will create radicals, and thus an improved generation of radicals is obtained in the zones where all fluid is passing. The design would also give a limited reduction of the volume processes. A further advantage is that the design will cause an increased turbulence in the casing, whereby it is possible to use the photo-catalysis of the casing in a more efficient way.

The nets also provide a filter function, where larger particles, organisms, and other objects are caught. The creation of radicals is the highest close to the photo-catalytic surfaces, and in particular so since they are very short-lived. This, on the other hand, provides an advantage when the photo-catalytic structure also has a filtering function since the organisms that need to be killed off are caught by the filter, and immediately exposed to large amounts of radicals produced by the UV light radiating the photo-catalytic surfaces of the filter.

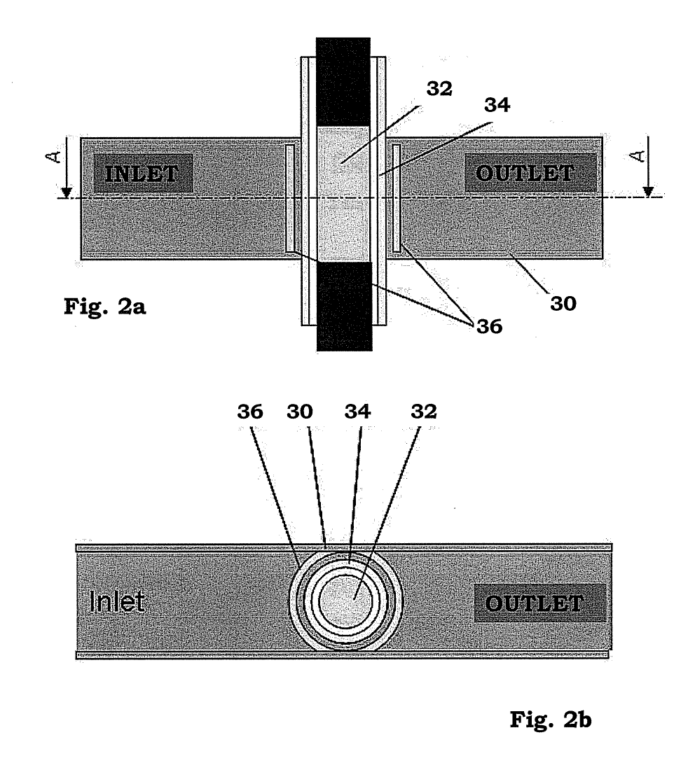

FIG. 2a,b shows an alternative embodiment of the present invention comprising a tubular casing 30, the ends of which are connected to a piping system containing fluid to be treated. In this embodiment a UV generating means 32 is arranged transversal to the flow direction, which UV generating means is placed in a UV light transparent tube 34 as with the previous embodiment. The quartz glass is in this embodiment surrounded by a tubular net structure 36made of, or covered with, photo-catalytic material.

With this design it is possible to use light sources capable of generating light with longer wavelengths and whereby the energy of the light is less sensitive to pollutions in the water. Examples of such light sources are different types of UV generating LED's, Xenon flash lamps, deuterium lamps, that further display the advantage of very short start-up times without extra wear. The short start-up times are very favourable in applications where the device is connected to tap water systems where the devices are used to clean the water. The filter aspect as mentioned in connection with the first embodiment is equally applicable for this embodiment.

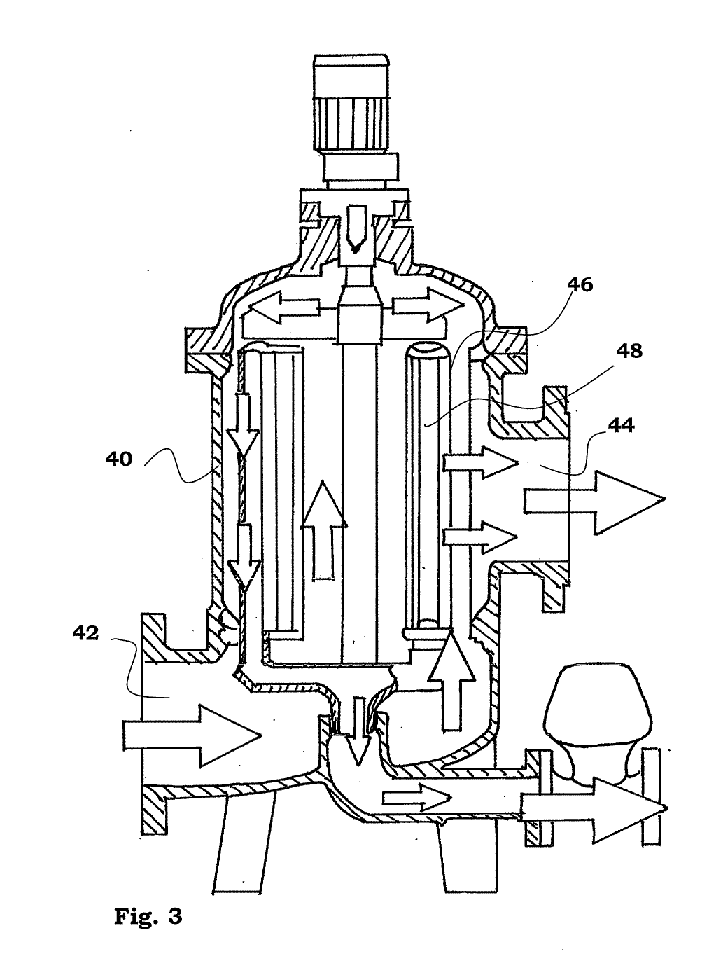

FIG. 3 displays a further embodiment arranged in a filter that is used e.g. in ballast water treatment systems. The filter comprises a housing 40 having a main inlet 42 and a main outlet 44 for the water to be filtered. Inside the housing a number of generally cylindrical tubular filter elements 46 are arranged such that the filtered water passes through the filter elements. According to the present invention UV generating lamps 48 are placed inside the tubular filter elements and the filter elements are made of, or covered with, photo-catalytic material as described above. In this way the filter is not only capable of mechanically removing larger objects and organisms but is also capable of killing off both larger organisms stuck in the filter as well as smaller organisms that may be capable of passing the filter. A very much increased operation of the filter is obtained with the present invention. Also, as mentioned above, a very powerful “treatment zone” is obtained on the surface of the filters, on which surface malicious organisms are stuck and killed.

The filters described above also have the further advantage that the treatment of fluid downstream of the filters is improved because there are no particles, organisms or objects that can disturb the distribution of UV light in the fluid to be treated.

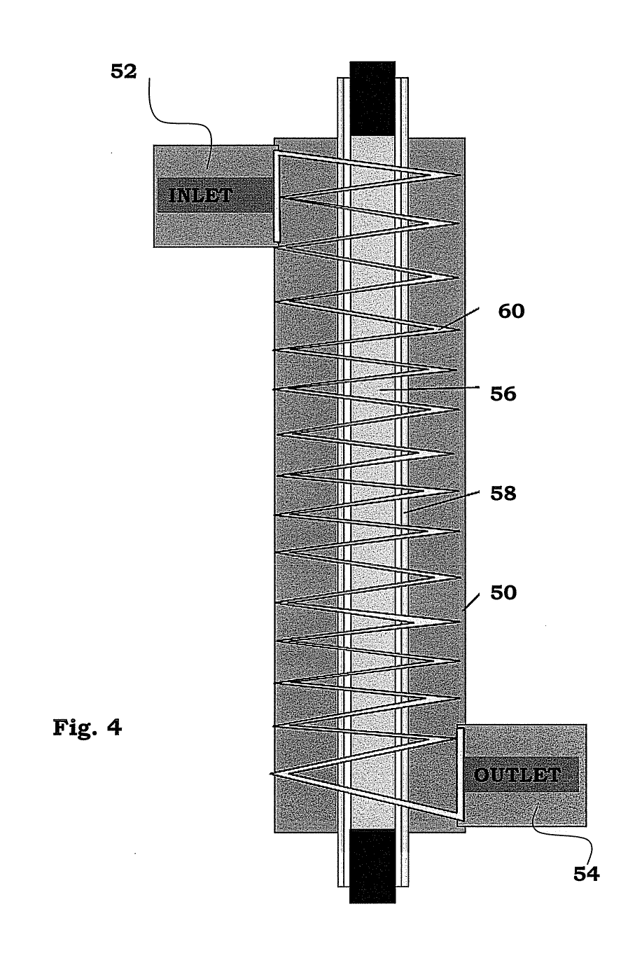

FIG. 4 shows a fourth embodiment, partly similar to the embodiment according to FIG. 1. It thus comprises a casing 50 with inlet 52 and outlet 54, a centrally placed UV lamp 56 surrounded by a protective quartz glass tube 58. Further, this embodiment is arranged with a catalytic structure 60 that is arranged as a spiral wound around the glass tube. The spiral is covered with catalytic material or having catalytic material embedded in the spiral material. The catalytic material may comprise any material metals, alloys and the like capable of creating photo-catalytic reactions in the fluid to be treated together with the UV radiation. Further the spiral is made of a material that has a high transparency for UV wavelengths above 240 nm. The spiral could either be solid or as a net or the like with perforations, and a preferable material is quartz glass. It has a few advantages such as being inert to most matter, it is a clean material and therefore usable in tap water applications as well as in the food industry, it may be covered with TiO2 with god adhesion, it may be spun to threads enabling manufacture of nets, and it may relatively easily be moulded to a suitable form.

With the design according to FIG. 4, it is possible to increase the active photo-catalytic area drastically, it is possible to obtain a photo-catalytic are in the whole volume and obtain photo-catalysis on the whole surface of the spiral, i.e. both on the front side and the back side. Further advantages are to maintain almost all photolysis induced by 185 nm closest to the lamp, maintain the majority of the direct acting 254 nm radiation in the whole volume, and maintain most of the photo-catalysis in the casing.

It is to be understood that the embodiments described above and shown in the drawings are to be regarded only as non-limiting examples of the invention and that it may be modified in many ways within the scope of the patent claims.

1. Device for treatment of fluids, comprising a treatment chamber having an inlet and an outlet for the fluid to be treated, elongated UV light generating means arranged inside said treatment chamber, a photo-catalytic structure arranged in said treatment chamber, that said photo-catalytic structure is a filter arranged in the flow of fluid through the treatment chamber such that the fluid flows through said filter, wherein said filter is designed generally tubular and placed adjacent and surrounding said UV light generating means for radiating said filter with UV light, thereby creating treatment radicals, and wherein said filter is placed such that the whole flow of fluid is forced through the radiated filter.

2. Device according to claim 1, wherein said photo-catalytic structure comprises a net structure having a plurality of openings through which the fluid may flow.

3. Device according to claim 1, wherein said photo-catalytic structure is made of a material displaying photo-catalytic properties.

4. Device according to claim 1, wherein the surfaces of said photo-catalytic structure are covered with a material displaying photo-catalytic properties.

5. Device according to claim 1, wherein a material displaying photo-catalytic properties is dispersed in the material of said photo-catalytic structure.

6. Device according to claim 1,wherein said photo-catalytic structure comprises a base material of quartz glass.

7. Device according to claim 1, where the mesh size is chosen such that the photo-catalytic structure acts as a filter.

8. Device according to claim 1, wherein said UV light generating means comprises low energy lamps such as LED's, Xenon flash lamps, deuterium lamps.

9. Device according to claim 1, wherein said catalytic material comprises titanium dioxide.

10. Device according to claim 1, wherein the inner surface of said treatment chamber is covered with material displaying photo-catalytic properties.

11. Device according to claim 2, wherein said photo-catalytic structure is made of a material displaying photo-catalytic properties.

12. Device according to claim 2, wherein the surfaces of said photo-catalytic structure are covered with a material displaying photo-catalytic properties.

13. Device according to claim 2, wherein a material displaying photo-catalytic properties is dispersed in the material of said photo-catalytic structure.
